(19) United States
(12) Patent Application Publication
(10) Pub. No.: US 2018/0262541 A1
(43) Pub. Date: Sep. 13, 2018

(54) INTERACTION WITH COMMUNAL MEETING DEVICE THROUGH BROADCAST OF IDENTITY

(71) Applicant: MICROSOFT TECHNOLOGY LICENSING, LLC, Redmond, WA (US)

(72) Inventors: Gregory Q. Fix, Seattle, WA (US); David C. Tse, Kirkland, WA (US)

(73) Assignee: MICROSOFT TECHNOLOGY LICENSING, LLC, Redmond, WA (US)

(21) Appl. No.: 15/455,717

(22) Filed: Mar. 10, 2017

(51) Int. Cl. H04L 29/06; H04W 4/00

(52) U.S. Cl. CPC H04L 65/403; H04L 65/1006; H04L 65/4076; H04W 4/008

(57) ABSTRACT

Technologies are described for interaction with a communal meeting device through broadcast of the device identity. The presence of a client device in a meeting space may be detected, for example, via a motion, a sound, an identity card read, or a connection of the client device to the communal meeting device. Upon detection of the client device, the communal meeting, device may broadcast its identity via short range wireless communication within the meeting space. The communal meeting device and the client device may establish, a short range wireless communication session on the broadcast identity, and the communal meeting device may provide two or more options associated with facilitating a meeting in conjunction with the communal meeting device and the client device based on the exchanged communication. A selected option nuts be received, and the meeting may be facilitated through a communication service per the selected option.

### BACKGROUND

Meeting spaces with communication and display technologies allow attendees to participate through various modalities in meetings, in person or remotely. With the proliferation in networking and computing technologies, meeting spaces are typically equipped with multiple display devices/systems, audio systems, and networking systems that allow coherent use of different devices and systems. Some meeting space technologies include a controller that may manage the different devices in the meeting space and allow attendees access to the meeting.

Conventional meeting space controllers, typically general purpose computing devices with one or more applications, require users manually activate relevant applications, control ancillary devices (e.g., display devices), etc. Thus, there is a cumbersome process involved in a meeting attendee attending or accessing a meeting in a meeting space.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to interaction with a communal meeting device through broadcast of identity. In some examples, a communal meeting device may detect presence of a client device in a meeting space and broadcast its identity via near field communication. In other examples, the communal meeting device may broadcast its identity without detecting the client device, for example, at regular intervals. Upon establishment of near field communication between the communal meeting device and the client device based on the broadcast identity, the communal meeting device may provide options associated with facilitating a meeting in conjunction with the communal meeting device and the client device.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 includes an example network environment where interaction with a communal meeting device through broadcast of identity may be implemented;

FIG. 2 includes a display diagram of a meeting space, where interaction with a communal meeting device through broadcast of identity may be implemented;

FIG. 3 includes another display diagram of a meeting space, where some features of interaction with a communal meeting device through broadcast of identity may be implemented;

FIG. 4 includes a further display diagram of a meeting space, where other features of interaction with a communal meeting device through broadcast of identity may be implemented;

FIG. 5 includes a yet another display diagram of a meeting space, where further features of interaction with a communal meeting device through broadcast of identity may be implemented;

FIG. 6 is a networked environment, where a system according to embodiments may be implemented;

FIG. 7 is a block diagram of an example communal meeting device, in accordance with some embodiments; and

FIG. 8 illustrates a logic flow diagram of a method for interaction with a communal meeting device through broadcast of identity, according to embodiments.

### DETAILED DESCRIPTION

As briefly described above, embodiments are directed to interaction with a communal meeting device through broadcast of identity. In some examples, a presence of a client device in a meeting space may be detected, for example, via a motion, a sound, an identity card read, a connection of the client device to the communal meeting device, or an initiation of an unscheduled meeting through the communal meeting device. Upon detection of the client device, the communal meeting device may broadcast its identity via short range wireless communication within the meeting space. The communal meeting device and the diem device may establish a short range wireless communication session on the broadcast identity, and the communal meeting device may provide two or more options associated with facilitating a meeting in conjunction with the communal meeting device and the diem device based on the exchanged communication. A selected option may be received via short range wireless communication, a wired connection, a long range wireless communication, or a user interface of the communal meeting device, and the meeting may be facilitated through a communication service according to the selected option.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for interaction with a communal meeting device through broadcast of identity. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing, devices viewed as a server on the network. More detail on these technologies and example operations is provided below.

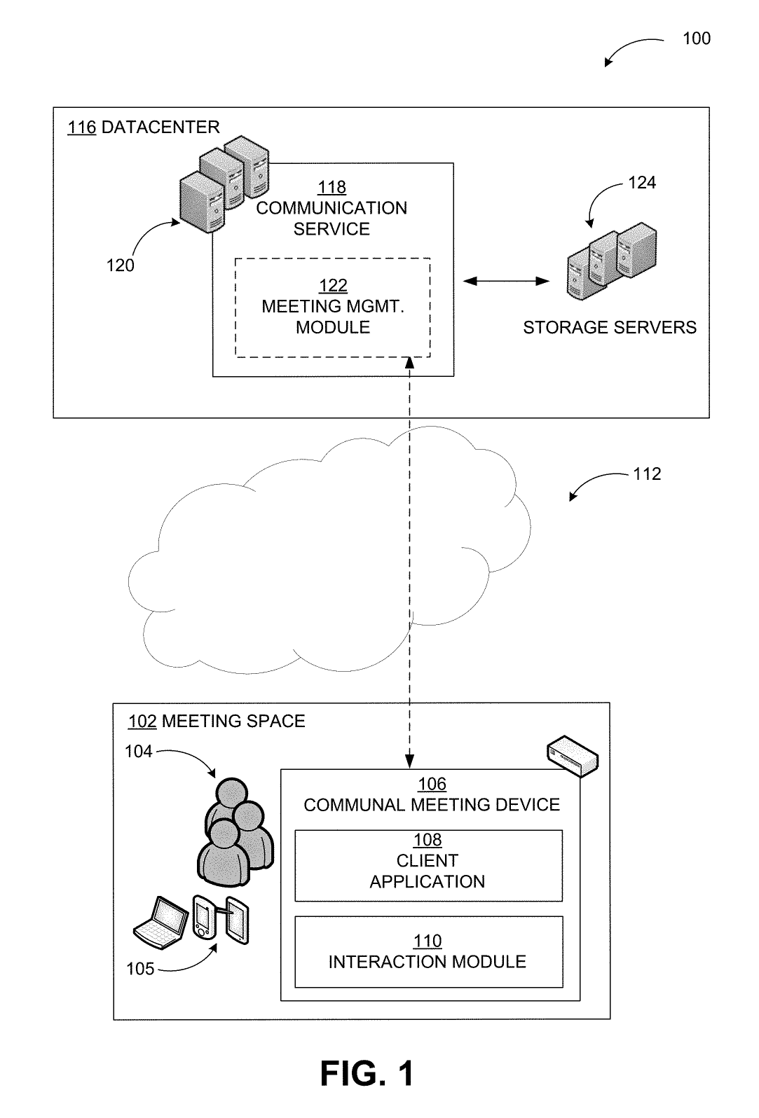

FIG. 1 includes, an example network environment where interaction with a communal meeting device through broadcast of identity may be implemented.

As illustrated in diagram 100, an example system may include a datacenter 116 hosting a cloud-based communication service 118 configured to enable users to share content, interact and communicate with one another, create and share calendars, and schedule meetings, among other things, through various communication modes, such as e-mail, text message, call and video conferencing and the like. The datacenter 116 may include one or more processing servers 120 configured to execute the communication service 118, among other components. In some embodiments, at least one of the processing servers 120 may be operable to execute an optional meeting management module 122 of the communication service 118, where the meeting management module 122 may be integrated with the communication service 118 to reserve/facilitate meetings that may involve a meeting space 102 for one or more users 104 through a communal meeting device 106 located within the meeting space 102. The datacenter 116 may also include one or more storage servers 124 configured to manage one or more data stores comprising data associated with content stored by the communication service 118 and/or data associated with the meeting management module 122. As described herein, the communication service 118 and/or meeting management module 122 may be implemented as software, hardware, or combinations thereof.

In some embodiments, the communication service 118 may be configured to interoperate with various applications to provide its services. For example, as illustrated in the diagram 100, a thin (e.g., a web browser) or a thick (e.g., a locally installed client application) version of a client application 108 may be executed by the communal meeting device 106 with which the communication service 118 may be configured to integrate and interoperate with over one or more networks, such as network 112. The client application 108 may be an application hosted by the communication service 118. The communal meeting device 106 may also include an interaction module 110 that may be configured to broadcast an identity for the communal meeting device 106, exchange information via short range communication with client devices in the meeting space 102, and provide information to the client application 108 for facilitating a meeting based on interaction with the client devices ands or attendants in the meeting space 102. The communal meeting device 106 may include special purpose device with custom hardware and/or software components, as well as, a desktop computer, a laptop computer, a tablet computer, a smart phone, and a wearable computing device with custom components among other similar devices. A communication interface may facilitate communication between the communication service 118 and the communal meeting device 106 over the network 112.

Embodiments as described herein, allow attendants to quickly and efficiently initiate and participate in meetings within a meeting space and take advantage of meeting features through their own client device or a communal meeting device. The automated interaction between the communal meeting device and client devices may reduce processing and memory resources, reduce consumed bandwidth, and increase user interactivity.

Embodiments, as described herein, address a need that arises from very large scale of operations created by software-based services that cannot be managed by humans. The actions/operations described herein are not a mere use of a computer, but address results of a system that is a direct consequence of software used as a service offered in conjunction with large numbers of users attempting to schedule meetings within a limited number of meeting spaces through communication services.

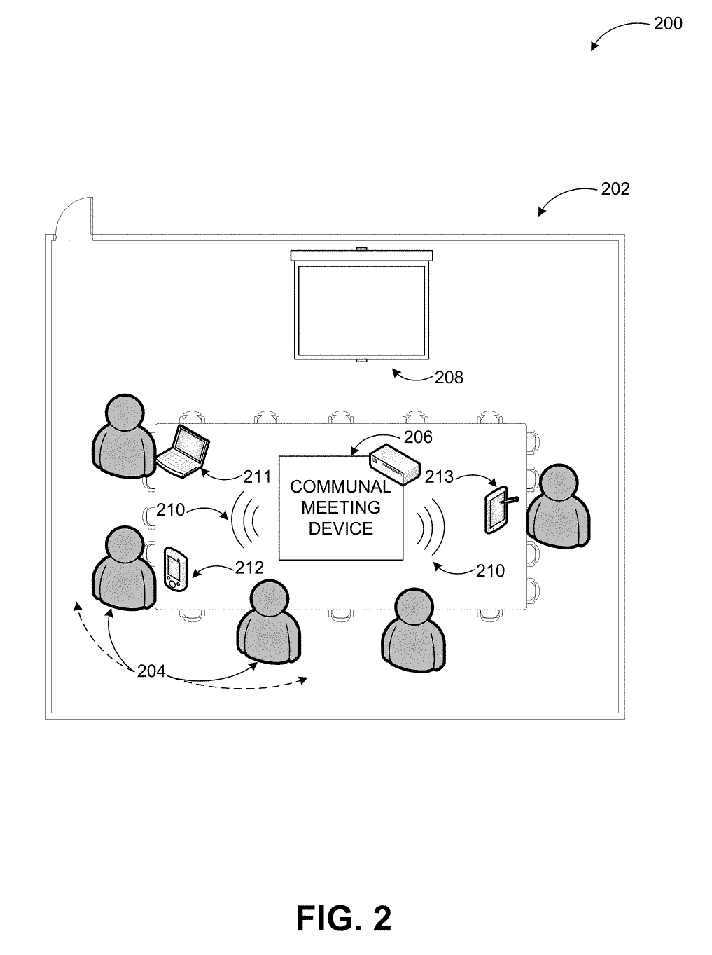

FIG. 2 includes a display diagram of a meeting space, where interaction with a communal meeting device through broadcast of identity may be implemented.

As shown in diagram 200, a meeting space 202 may include a communal meeting device 206 and one or more ancillary devices such as a display 208. The communal meeting device 206 may be special purpose device or a customized general purpose computing device among other similar devices and be configured to facilitate meetings in conjunction with a communication or meeting service (e.g., communication service 118). The communal meeting, device 206 may, for example, manage the ancillary, devices in the meeting space 202, provide a user interface to access or initiate a meeting, and manage meeting features such as audio/video controls, presentations, recordings. etc.

According to some embodiments, the communal meeting device 206 may be configured to detect a presence of a client device such as client devices 211, 212, and 213 associated with attendants 204 in the meeting space 202, for example, via a motion, a sound, an identity card read, a connection of the client device to the communal meeting device, or an initiation of an unscheduled meeting through the communal meeting device. Upon detection of the client device(s) or periodically, the communal meeting device may broadcast its identity 210 via short range wireless communication within the meeting space. The short range wireless communication may include near field communication (NFC), Bluetooth communication, personal area network (PAN) communication, optical communication, and comparable ones.

The communal meeting device and the client device(s) may establish a short range wireless communication session based on the broadcast identity 210. The communication session may include exchange of the identity of the communal meeting device and an identity of the client device, exchange of information associated with one or more capabilities of the communal meeting device and the client, device, or authentication of one or more of the client device and an attendant using the client device to the communication service, for example. The broadcast identity 210 may be a name (also referred to as “friendly name”), a session initiation protocol (SIP) address, an email address, or an alphanumeric code associated with the communal meeting device.

The communal meeting device 206 may then provide options associated with facilitating a meeting in conjunction with the communal meeting device 206 and the client devices(s) 211-213 based on the exchanged communication. A selected option may be received via short range wireless communication, a wired connection, a long range wireless communication, or a user interface of the communal meeting device, and the meeting may be facilitated through a communication service according to the selected option.

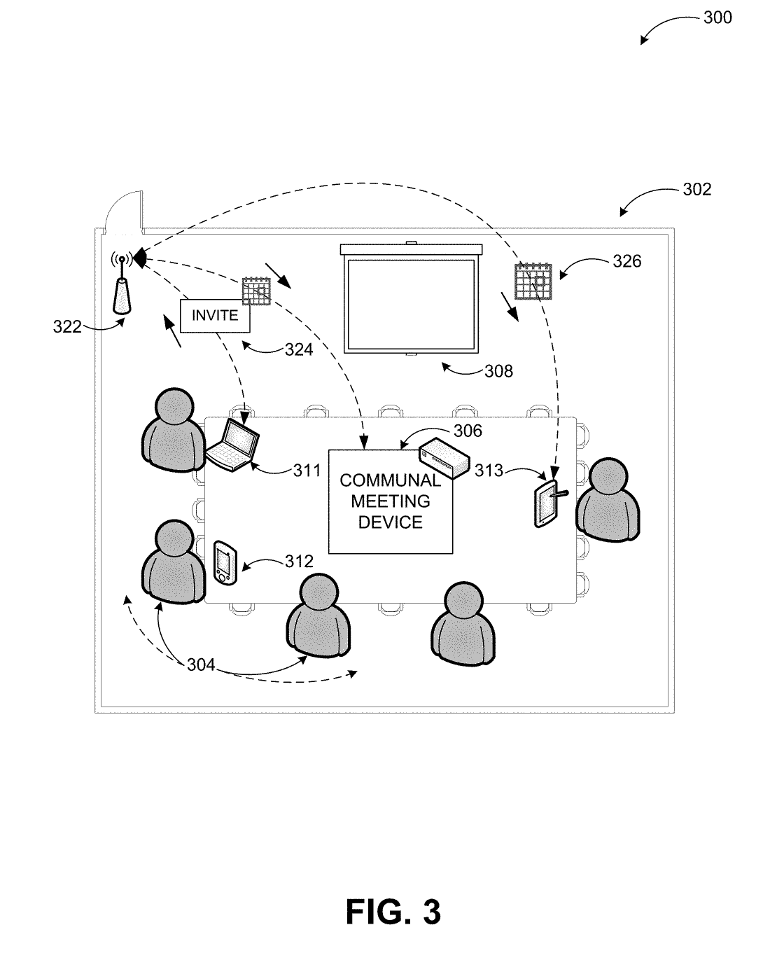

FIG. 3 includes another display diagram of a meeting space, where some features of interaction with a communal meeting device through broadcast of identity may be implemented.

Diagram 300 shows conceptually the presentation and selection of meeting related options upon establishment of a short range communication between the communal meeting device 306 and client devices 311-313 in the meeting space 302. The client devices 311-313 associated with attendants 304 may be different devices with different capabilities. Furthermore, different attendants may select different meeting related options. The options related to the meeting presented by the communal meeting device 306 may include enabling an attendant to send a meeting invite for the meeting to the communal meeting device to allow facilitation of the meeting through the communal meeting device, enabling the attendant move the meeting to the communal meeting device from the client device, providing a Joint management of available display and audio devices in the meeting space between the communal meeting device and the client device, and following the establishment of the short range wireless communication session providing one of a wired and a wireless connectivity to a network associated with the meeting space through the communal meeting device to the client device. Selected options may be received by the communal meeting device 306 via short range wireless communication, a wired connection, a long range wireless communication, or a user interface of the communal meeting device 306.

In some embodiments, the options may be determined automatically for a particular attendant. For example, the communal meeting device 306 or an underlying communication (meeting) service may determine an identity of the attendant using a client device through the short range communication and select a meeting option based on the identity of the attendant (e.g. past usage, preferences on record, permission levels, etc.).

In an example scenario, an attendant using a small form client device such as a tablet may prefer to move the meeting to the communal meeting device 306. Thus, the attendant may select the option through their tablet device or through the user interface of the communal meeting device 306 and participate in the meeting through the communal meeting device 306. Another attendant may use a laptop computer and select the option to invite the communal meeting device 306 to the meeting. As a result, the communal meeting device 306 and its capabilities (e.g., audio/video controls) may become part of the meeting. While the attendant is using their laptop computer to present content to the meeting attendants, audio (e.g., speakers) may be managed by the communal meeting device 306.

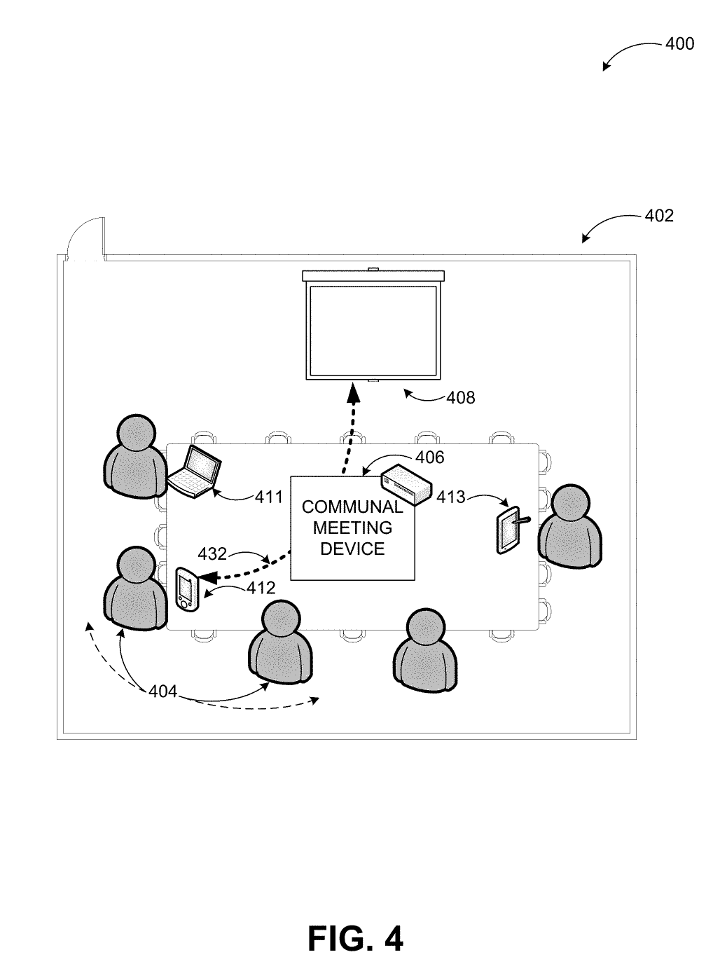

FIG. 4 includes a further display diagram of a meeting space, where other features of interaction with a communal meeting device through broadcast of identity may be implemented.

Diagram 400 shows conceptually shared use of ancillary devices in the meeting space 402. Some of the client devices 411-413 may have different forms and capabilities, some of which may not be suitable for the meeting. Thus, attendants 404 may select an option to share resources of the meeting space 402 with the communal meeting device 406 through the short range communication session with their client device, through another (wired or long range wireless communication) connection, or through the user interface of the communal meeting device 406.

In an example scenario, one attendant may use a smart phone as client device and select the option of screen sharing for the meeting. As a result, the communal meeting device 406 may provide connection to the display 408 in the meeting space 402 and allow that attendant to control the display 408 through their smart phone during the meeting (e.g., to present a document or similar content).

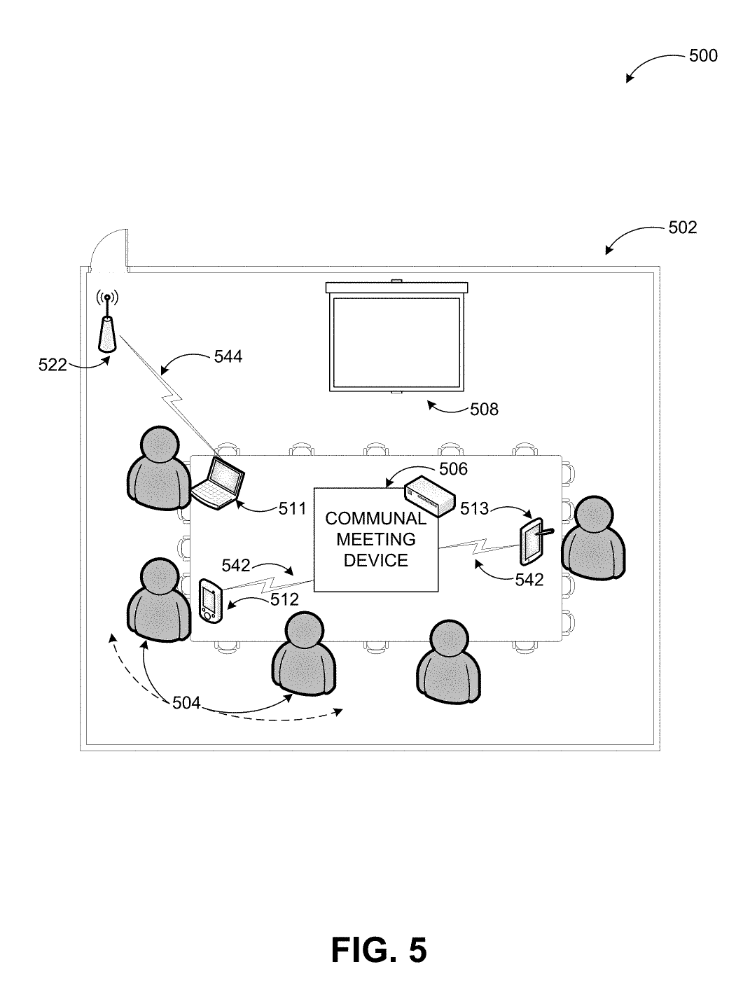

FIG. 5 includes a yet another display diagram of a meeting space, where further features of interaction with a communal meeting device through broadcast of identity may be implemented.

Diagram 500 shows conceptually yet another meeting option, provision of other connectivity through the communal meeting device 506. In some embodiments, an access point 522 or similar wireless networking device within or outside of the meeting space 502 may provide network connectivity to various client devices 511-513 associated with attendants 504. For example, an attendant may select screen sharing and provide content to be displayed on the display 508 through the communal meeting device 506 via short range communication. At the same time, the attendant may actually participate in the meeting through their client device via a long range wireless connection through the access point 522.

In cases where the attendant may not be able to or may not prefer to use the network connectivity through the access point 522, the communal meeting device 506 may provide a broad hand connection 542 to the client device. The connection may be a tong range wireless communication connection (e.g., wireless local area network “WLAN” or similar). In other examples, the communal meeting device 506 may determine the client device's capabilities and/or the attendant's preferences during the short range communication session and provide a suitable connection automatically. For example, during the short range communication session, the communal meeting device 506 may determine that an attendant's client device is not connected to the wireless network in the building, but the attendant wishes to use their client device to connect to the meeting. Thus, the communal meeting device 506 may present an option to connect the two devices via a wired connection (e.g., HDMI) or through a wireless connection (e.g., name and password Iona local area network hosted by the communal meeting device 506) allowing the attendant to participate in the meeting through their client device without having to connect to the building network.

The examples provided in FIGS. 1 through 5 are illustrated with specific systems, services, applications, modules, and notifications. Embodiments are not limited to environments according to these examples. Interaction with a communal meeting device through broadcast of identity may be implemented in environments employing fewer or additional systems, services, applications, modules, and notifications. Furthermore, the example systems, services, applications, modules, and notifications shown in FIG. 1 through 5 may be implemented in a similar manner with other values using the principles described herein.

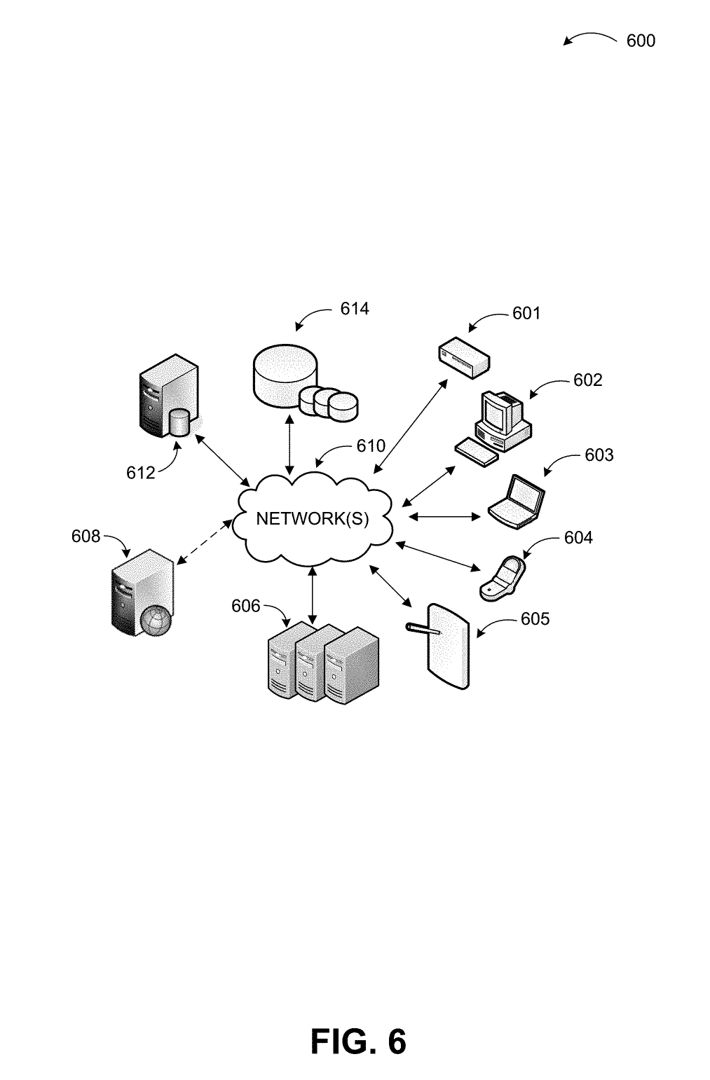

FIG. 6 is a networked environment, where a system according to embodiments may be implemented. In addition to locally installed applications (for example, client application 108), an interaction module may also be employed in conjunction with hosted applications and services (for example, a communication service 118) that may be implemented via software executed over one or more servers 606 or individual server 608, as illustrated in diagram 600. A hosted service or application may communicate with client applications on individual computing devices such as a communal meeting device 601, a desktop computer 602, a laptop computer 603, a smart phone 604, a tablet computer (or slate), 605 (‘client devices’) through network(s) 610 and control a user interface presented to users.

Client devices 601-605 are used to access the functionality provided by the hosted service or application. One or more of the servers 606 or server 608 may be used to provide a variety of services as discussed above. Relevant data may be stored in one or more data stores (e.g. data store 614), which may he managed by any one of the servers 606 or by database server 512.

Network(s) 610 may comprise any topology of servers, clients, Internet service providers, and communication media. A system according to embodiments may have a static or dynamic topology. Network(s) 610 may include a secure network such as an enterprise network, an unsecure network such as a wireless open network, or the Internet. Network(s) 610 may also coordinate communication over other networks such as PSTN or cellular networks. Network(s) 610 provides communication between the nodes described herein. By way of example, and not limitation, network(s) 610 may include wireless media such as acoustic, RF, infrared and other wireless media.

Many other configurations of computing devices, applications, engines, data sources, and data distribution systems may be employed for interaction with a communal meeting device through broadcast of identity. Furthermore, the networked environments discussed in FIG. 6 are for illustration purposes only. Embodiments are not limited to the example applications, engines, or processes.

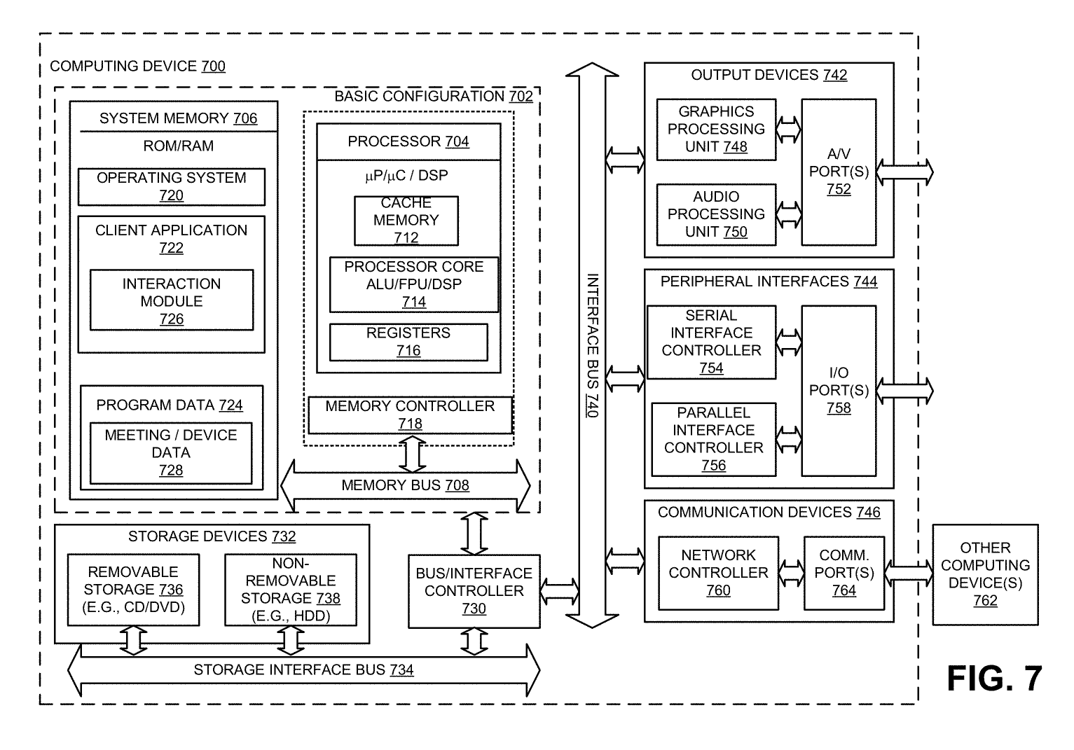

FIG. 7 is a block diagram of an example communal meeting device, in accordance with some embodiments.

For example, computing device 700 may be a communal meeting device, where the communal meeting device may be used as a server, desktop computer, portable computer, smart phone, special purpose computer, or similar device. In an example basic configuration 702, the computing device 700 may include one or more processors 704 and a system memory 706. A memory bus 708 may be used for communicating between the processor 704 and the system memory 706. The basic configuration 702 is illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one more levels of caching, such as a level cache memory 712, one or more processor cores 714, and registers 716. The example processor cores 714 may (each) include an arithmetic logic unit (ALU), a floating point unit (FPU), a digital signal processing core (DSP Core), or any combination thereof. An example memory controller 718 may also be used with the processor 704, or in some implementations the memory controller 718 may be an internal part of the processor 704.

Depending on the desired configuration, the system memory 706 may be of any type including but not limited to volatile memory (such as RAM), non-volatile memory (such as ROM, flash memory, etc.) or any combination thereof. The system memory 706 may include an operating system 720, a client application 722 associated with a communication service such as a meeting application, and program data 724. The client application 722 may include an interaction module 726. Upon detection of a client device within the meeting space or at regular intervals, the interaction module 726 may be configured to broadcast an identity of the communal meeting device via short range wireless communication within the meeting space and provide options associated with facilitating a meeting in conjunction with the communal meeting device and the client device upon establishment of a short range wireless communication session between the communal meeting device and the client device based on the broadcast identity. The client application 722 may then facilitate the meeting according to a selected option. The program data 724 may include, among other data, meeting/device data 728, such as meeting specifics, client device types, and connectivity information, etc., as described herein.

The computing device 700 may have additional features or functionality, and additional interfaces to facilitate communications between the basic configuration 702 and any desired devices and interfaces. For example, a bus/interface controller 730 may be used to facilitate communications between the basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 746) to the basic configuration 702 via the bus/interface controller 730. Some of the example output devices 742 include a graphics processing unit 748 and an audio processing unit 750, which may be configured to communicate to various external devices such as a display or speakers via one or more A/V ports 752. One or more example peripheral interfaces 744 may include a serial interface controller 754 or a parallel interface controller 756, which may be configured to communicate with external devices such as input devices (for example, keyboard, mouse, pen, voice input device, touch input device, etc.) or other peripheral devices (for example, printer, scanner, etc.) via one or more I/O ports 758. An example communication device 746 includes a network controller 760, which may be arranged to facilitate communications with one or more other computing devices 762 over a network communication link via one or more communication ports 764. The one or more other computing devices 762 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not communication media may include wired media such as a wired network or direct-wired connection, and wireless media such as acoustic, radio frequency (RF) microwave, infrared (IR) and other wireless media. The term computer readable media as used herein may include both storage media and communication media.

The computing device 700 may be implemented as a part of a specialized server, mainframe, or similar computer that includes any of the above functions. The computing device 700 may also be implemented as a personal computer including both laptop computer and non-laptop computer configurations.

Example embodiments may also include methods for interaction with a communal meeting device through broadcast of identity, in accordance with some embodiments. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

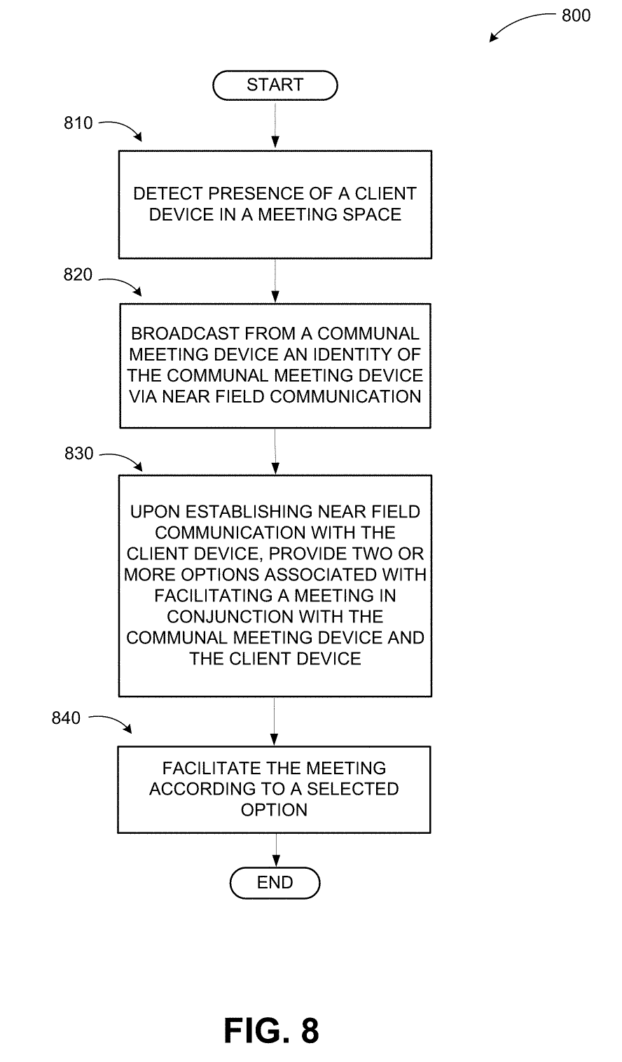

FIG. 8 illustrates a logic flow diagram of a method for interaction with a communal meeting device through broadcast of identity, according to embodiments.

Process 800 may be implemented on a computing device, server, or other system. An example system may include a server configured to execute a communication service and a communal meeting device configured to meetings in a meeting space for attendees. The communal meeting device may include a communication interface to facilitate communication between the communication service and the communal meeting device, a memory to store instructions, and one or more processors coupled to the memory.

Process 800 begins with operation 810, where the communal meeting device may detect a presence of a client device in a meeting space via one or more of a motion, a sound, an identity card read, a connection of the client device to the communal meeting device, and an initiation of an unscheduled meeting through the communal meeting device.

Upon detection of the client device or at regular intervals, the communal meeting device may broadcast its identity via short range wireless communication within the meeting space at operation 820. The broadcast identity may include a name, a session initiation protocol (SIP) address, an email address, and/or an alphanumeric code associated with the communal meeting device.

At operation 830, the communal meeting device may provide options associated with facilitating a meeting in conjunction with the communal meeting device and the client device upon establishment of a short range wireless communication session between the communal meeting device and the client device based on the broadcast identity. In some examples, the options may include enabling an attendant to send a meeting invite for the meeting to the communal meeting device to allow facilitation of the meeting through the communal meeting device, enabling the attendant move the meeting to the communal meeting device from the client device, providing a joint management of available display and audio devices in the meeting space between the communal meeting device and the client device, and following the establishment of the short range wireless communication session providing one of a wired and a wireless connectivity to a network associated with the meeting space through the communal meeting device to the client device.

At operation 840, the communal meeting device may receive a selected option via short range wireless communication, a wired connection, a long range wireless communication, or a user interface of the communal meeting device, and facilitate the meeting through the communication service according to the selected option.

The operations included in process 800 are for illustration purposes. Interaction with a communal meeting device through broadcast of identity may be implemented by similar processes with fewer or additional steps, as well as in different order of operations using the principles described herein. The operations described herein may be executed by One or more processors operated on one or more computing devices, one or more processor cores, and/or one or more specialized processing devices, among other examples.

According to examples, a means for interacting with a communal meeting device through broadcast of identity is described. The means may include a means for detecting a presence of a client device in a meeting space; a means for broadcasting an identity of the communal meeting device via short range wireless communication within the meeting space; a means for providing two or more options associated with facilitating a meeting in conjunction with the communal meeting device and the client device upon establishment of a short range wireless communication session between the communal meeting device and the client device based on the broadcast identity; and a means for facilitating the meeting according to a selected option.

According to some examples, a method for interaction with a communal meeting device through broadcast of identity is described. The method includes detecting a presence of a client device in a meeting space; broadcasting an identity of the communal meeting device via short range wireless communication within the meeting space; upon establishment of a short range wireless communication session between the communal meeting device and the client device based on the broadcast identity, providing two or more options associated with facilitating a meeting in conjunction with the communal meeting device and the client device; and facilitating the meeting according to a selected option.

According to other examples, providing the two or more options associated with facilitating the meeting may include enabling an attendant to send a meeting invite for the meeting to the communal meeting device to allow facilitation of the meeting through the communal meeting device; and enabling the attendant move the meeting to the communal meeting device from the client device. Providing the two or more options associated with facilitating the meeting may further include providing a joint management of available display and audio devices in the meeting space between the communal meeting device and the client device.

According to further examples, providing the two or more options associated with facilitating the meeting may further include following the establishment of the short range wireless communication session providing one of a wired and a wireless connectivity to a network associated with the meeting space through the communal meeting device to the client device. Broadcasting the identity of the communal meeting device may include transmitting one or more of a name, a session initiation protocol (SIP) address, an email address, and an alphanumeric code associated with the communal meeting device. Broadcasting the identity of the communal meeting device may also include transmitting the identity of the communal meeting device via one or more of a short range wireless communication medium, a king range wireless communication medium, a wired communication medium, and an optical communication medium. Detecting the presence of the client device may include detecting one or more of a motion, a sound, an identity card read, a connection of the client device to the communal meeting device, and an initiation of an unscheduled meeting through the communal meeting device.

According to some examples, the method may also include receiving the selected option via one of short range wireless communication, a wired connection, a long range wireless communication, and a user interface of the communal meeting device. The method may further include exchanging the identity of the communal meeting device and an identity of the client device through the established short range wireless communication session. The method may also include exchanging information associated with one or more capabilities of the communal meeting device and the client device through the established short range wireless communication session. The method may further include authenticating one or more of the client device and an attendant using the client device to a communication service through the established short range wireless communication session.

According to other examples, a communal meeting device located within a meeting space and configured to broadcast an identity for interaction is described. The communal meeting device may include a communication interface configured to facilitate communication between one or more servers executing a communication service and the communal meeting device; a memory configured to store instructions; and one or more processors coupled to the memory. The one or more processors, in conjunction with the instructions stored in the memory, may be configured to detect a presence of a client device in the meeting space; broadcast the identity of the communal meeting device via short range wireless communication within the meeting space; upon establishment of a short range wireless communication session between the communal meeting device and the client device based on the broadcast identity, provide two or more options associated with facilitating a meeting in conjunction with the communal meeting device and the client device; receive a selected option via one of short range wireless communication, a wired connection, a long range wireless communication, and a user interface of the communal meeting device; and facilitate the meeting according to the selected option.

According to some examples, the communal meeting device may further include one or more sensors and one or more inputs to detect the presence of the client device via one or more of a motion, a sound, an identity card read, a connection of the client device to the communal meeting device, and an initiation of an unscheduled meeting through the communal meeting device. The short range wireless communication session may be established via one of near field communication (NFC), Bluetooth communication, personal area network (PAN) communication, and optical communication. The established short range wireless communication session may include one or more of exchange of the identity of the communal meeting device and an identity of the client device; exchange of information associated with one or more capabilities of the communal meeting device and the client device; and authentication of one or more of the client device and an attendant using the client device to the communication service. The client device may include a desktop computer, a laptop computer, a tablet computer, a smart phone, or a wearable computing device.

According to further examples, a system for interaction with a communal meeting device through broadcast of identity is described. The system may include a server configured to execute a communication service and a communal meeting device. The communal meeting device may include a communication interface configured to facilitate communication between one or more servers executing the communication service and the communal meeting device; a memory configured to store instructions; and one or more processors coupled to the memory. The one or more processors, in conjunction with the instructions stored in the memory, may be configured to detect a presence of a client device in a meeting space via one of more of a motion, a sound, an identity card read, a connection of the client device to the communal meeting device, and an initiation of an unscheduled meeting through the communal meeting device; broadcast the identity of the communal meeting device via short range wireless communication within the meeting space; upon establishment of a short range wireless communication session between the communal meeting device and the client device based on the broadcast identity, provide two or more options associated with facilitating a meeting in conjunction with the communal meeting device and the client device; receive a selected option via one of short range wireless communication, a wired connection, a long range wireless communication, and a user interface of the communal meeting device; and facilitate the meeting through the communication service according to the selected option.

According to other examples, the one or more processors may be further configured to determine an identity of an attendant using the client device; and provide the identity of the attendant to the communication service in order to facilitate the meeting. The one or more processors may also be configured to determine the identity of the attendant during the established short range wireless communication session. The two or more options may include enabling an attendant to send a meeting invite for the meeting to the communal meeting device to allow facilitation of the meeting through the communal meeting device, enabling the attendant move the meeting to the communal meeting device from the client device, providing a joint management of available display and audio devices in the meeting space between the communal meeting device and the client device, and following the establishment of the short range wireless communication session providing one of a wired and a wireless connectivity to a network associated with the meeting space through the communal meeting device to the client device.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method for interaction with a communal meeting device through broadcast of identity, the method comprising:
detecting a presence of a client device in a meeting space;
broadcasting an identity of the communal meeting device via short range wireless communication within the meeting space;
upon establishment of a short range wireless communication session between the communal meeting device and the client device based on the broadcast identity, providing two or more options associated with facilitating a meeting in conjunction with the communal meeting device and the client device; and
facilitating the meeting according to a selected option.

2. The method of claim 1, wherein providing the two or more options associated with facilitating the meeting comprises:
enabling an attendant to send a meeting invite for the meeting to the communal meeting device to allow facilitation of the meeting through the communal meeting device; and
enabling the attendant move the meeting to the communal meeting device from the client device.

3. The method of claim 2, wherein providing the two or more options associated with facilitating the meeting further comprises:
providing a joint management of available display and audio devices in the meeting space between the communal meeting device and the client device.

4. The method of claim 3, wherein providing the two or more options associated with facilitating the meeting further comprises:
following the establishment of the short range wireless communication session providing one of a wired and a wireless connectivity to a network associated with the meeting space through the communal meeting device to the client device.

5. The method of claim 1, wherein broadcasting the identity of the communal meeting device comprises:
transmitting one or more of a name, a session initiation protocol (SIP) address, an email address, and an alphanumeric code associated with the communal meeting device.

6. The method of claim 1, wherein broadcasting the identity of the communal meeting device comprises:
transmitting the identity of the communal meeting device via one or more of a short range wireless communication medium, a long range wireless communication medium, a wired communication medium, and an optical communication medium.

7. The method of claim 1, wherein detecting the presence of the client device comprises:
detecting one or more of a motion, a sound, an identity card read, a connection of the client device to the communal meeting device, and an initiation of an unscheduled meeting through the communal meeting device.

8. The method of claim 1, further comprising:
receiving the selected option via one of short range wireless communication, a wired connection, a long range wireless communication, and a user interface of the communal meeting device.

9. The method of claim 1, further comprising:
exchanging the identity of the communal meeting device and an identity of the client device through the established short range wireless communication session.

10. The method of claim 9, further comprising:
exchanging information associated with one or more capabilities of the communal meeting device and the client device through the established short range wireless communication session.

11. The method of claim 9, further comprising:
authenticating one or more of the client device and an attendant using the client device to a communication service through the established short range wireless communication session.

12. A communal meeting device located within a meeting space and configured to broadcast an identity for interaction, the communal meeting device comprising:
a communication interface configured to facilitate communication between one or more servers executing a communication service and the communal meeting device;
a memory configured to store instructions; and
one or more processors coupled to the memory, wherein the one or more processors, in conjunction with the instructions stored in the memory, are configured to:
detect a presence of a client device in the meeting space;
broadcast the identity of the communal meeting device via short range wireless communication within the meeting space;
upon establishment of a short range wireless communication session between the communal meeting device and the client device based on the broadcast identity, provide two or more options associated with facilitating a meeting in conjunction with the communal meeting device and the client device;
receive a selected option via one of short range wireless communication, a wired connection, a long range wireless communication, and a user interface of the communal meeting device; and
facilitate the meeting according to the selected option.

13. The communal meeting device of claim 12, further comprising:
one or more sensors and one or more inputs to detect the presence of the client device via one or more of a motion, a sound, an identity card read, a connection of the client device to the communal meeting device, and an initiation of an unscheduled meeting through the communal meeting device.

14. The communal meeting device of claim 12, wherein the short range wireless communication session is established via one of near field communication (NFC), Bluetooth communication, personal area network (PAN) communication, and optical communication

15. The communal meeting device of claim 12, wherein the established short range wireless communication session includes one or more of:
exchange of the identity of the communal meeting device and an identity of the client device;
exchange of information associated with one or more capabilities of the communal meeting device and the client device; and
authentication of one or more of the client device and an attendant using the client device to the communication service.

16. The communal meeting device of claim 12, wherein the client device includes one of a desktop computer, a laptop computer, a tablet computer, a smart phone, and a wearable computing device.

17. A system for interaction with a communal meeting device through broadcast of identity, the system comprising:
a server configured to execute a communication service; and
a communal meeting device comprising:
a communication interface configured to facilitate communication between one or more servers executing the communication service and the communal meeting device;
a memory configured to store instructions; and
one or more processors coupled to the memory, wherein the one or more processors, in conjunction with the instructions stored in the memory, are configured to:
detect a presence of a client device in a meeting space via one or more of a motion, a sound, an identity card read, a connection of the client device to the communal meeting device, and an initiation of an unscheduled meeting through the communal meeting device;
broadcast the identity of the communal meeting device via short range wireless communication within the meeting space;
upon establishment of a short range wireless communication session between the communal meeting device and the client device based on the broadcast identity, provide two or more options associated with facilitating a meeting in conjunction with the communal meeting device and the client device;
receive a selected option via one, of short range wireless communication, a wired connection, a long range wireless communication, and a user interface of the communal meeting device; and
facilitate the meeting through the communication service according to the selected option.

18. The system of claim 17, wherein the one or more processors are further configured to:
determine an identity of an attendant using the client device; and
provide the identity of the attendant to the communication service in order to facilitate the meeting.

19. The system of claim 18, wherein the one or more processors are further configured to:
determine the identity of the attendant during the established short range wireless communication session.

20. The system of claim 17, wherein the two or more options include enabling an attendant to send a meeting invite for the meeting to the communal meeting device to allow facilitation of the meeting through the communal meeting device, enabling the attendant move the meeting to the communal meeting device from the client device, providing a joint management of available display and audio devices in the meeting space between the communal meeting device and the client device, and following the establishment of the short range wireless communication session providing one of a wired and a wireless connectivity to a network associated with the meeting space through the communal meeting device to the client device.
